(19) United States
(12) Patent Application Publication
(10) Pub. No.: US 2026/0225184 A1
(43) Pub. Date: Aug. 6, 2026

(54) APPARATUS AND METHOD FOR PRODUCING FLAT SHAPED ELEMENTS

(71) Applicant: ENDICO S.R.L., Buja (UD) (IT)

(72) Inventor: Franco Zuliani, Osoppo (UD) (IT)

(73) Assignee: ENDICO S.R.L., Buja (UD) (IT)

(21) Appl. No.: 19/157,402

(22) PCT Filed: Feb. 13, 2024
(86) PCT No.: PCT/IT2024/050034

§ 371 Date: Aug. 18, 2025

(30) Foreign Application Priority Data
Feb. 16, 2023 (IT) 102023000002622

(51) Int. Cl. B23K 26/08; B23K 26/064; B23K 37/02; B25J 9/00

(52) U.S. Cl. CPC B23K 26/0884; B23K 26/064; B23K 37/0211; B25J 9/0051

(57) ABSTRACT

The present application relates to an apparatus (10) and a method for producing flat shaped elements (11), comprising at least one laser source (12) for feeding a laser beam (R) to a fixed focal length laser head (13) for processing said flat elements (11) using a delta robot (14) provided with a plurality of mechanical arms (28a, 28b, 28c) which are associated with said laser head (13) in order to move the latter, and an optical system (15, 45) for deflecting said laser beam (R) which receives said laser beam (R) from said laser source (12) and sends it to at least a second deflection device (17) integral with said laser head (13).

### FIELD OF THE INVENTION

The present invention concerns an apparatus and a method for producing flat shaped elements, in particular staring from sheets of paper, paperboard, corrugated cardboard, to perform cutting, marking and incision operations, or suchlike.

### BACKGROUND OF THE INVENTION

As is known, there exist apparatuses for producing flat shaped elements, or “plotters”, consisting of a two-axis Cartesian robot, which move a fixed focal length laser head.

These plotters operate mainly in static mode, that is, the material to be processed is placed on a fixed plane arranged in correspondence with a movement device, or plotter. The plotter works on the flat element, performing for example cutting, marking, or other processes, following the geometric profile determined by the mother graphic and converted into interpolated linear movements of the apparatus' motors. The material to be cut is static and it is translated automatically or manually at the end of processing, generating a “dead time” that significantly impacts the productivity of the system.

Apparatuses for producing flat shaped elements are also known that provide galvanometric scanning heads associated with laser systems that use a series of mirrors that dynamically deflect the laser beam onto the material, obtaining the desired cutting geometry.

Substantially, these galvanometric heads do not move and are attached above the work area. In this case, the laser beam is directed onto the material, even in motion, by means of mirrors contained inside the galvanometric head itself. This technology has important limitations that hinder the mass diffusion of the laser solution, especially for the “converting” of large format materials.

Specifically, the limits of this technology are dimensional, since the galvanometric heads allow for an accepted cutting quality only with work areas that, on average, are a fraction of what is required by the market. Current manufacturers of laser converting machines for the reference market offer solutions with a maximum format of 1000×700mm, obtained by placing two galvanometric heads side by side, which have considerable costs.

Another limitation of the above technology is the impossibility of achieving a perpendicular cut, since the laser beam impacts the material with an angle variable by up to 22°. Particularly in the field of corrugated cardboard die-cutting, this is not accepted because the cut has to necessarily be perpendicular to the surface of the cardboard itself.

Another limitation of the aforementioned technology is the need for considerable powers of the laser source, because the energy focused by a scanning head is distributed over a greater area than that focused by a fixed focal length head.

Document FR2663583A1 concerns a device for automatically orienting a tool. In particular, said document describes a generic and known robotic system with independent robotic arms.

Document EP2740563A1 concerns a processing machine and a method for moving a processing head. This document describes, in particular, a parallel robotic system for moving the processing head.

Despite the use of these robotic systems, these documents do not disclose an effective and precise system for moving the laser head and therefore an effective system for processing flat elements.

There is therefore the need to perfect an apparatus and a method for producing flat shaped elements that can overcome at least one of the disadvantages of the state of the art.

In particular, one purpose of the present invention is to obtain an apparatus for producing flat shaped elements that is efficient and allows for a significant increase in productivity compared to the apparatuses known in the sector.

Another purpose of the present invention is to obtain an apparatus for producing flat shaped elements that allows to carry out processing with high performance, great precision and substantially continuously, even on large work areas.

Another purpose of the present invention is to obtain an apparatus for producing flat shaped elements that allows to carry out the required processing much more rapidly than what occurs in the apparatuses known in the sector.

Another purpose of the present invention is to obtain an apparatus for producing flat shaped elements that has low costs, for example thanks to the fact that galvanometric heads are not used.

Another purpose of the present invention is to obtain an apparatus for producing flat shaped elements that allows to obtain a perpendicular cut.

Another purpose of the present invention is to obtain an apparatus for producing flat shaped elements that has a lower environmental impact because, thanks to its efficiency and speed, the power required for processing and therefore the consumption of electrical energy is drastically reduced.

Yet another purpose of the present invention is to obtain an apparatus for producing flat shaped elements that allows to continuously modify the shape of the flat element, while maintaining processing speeds and performances comparable to traditional cutting systems that are generally used to obtain flat elements which all have the same shape.

Another purpose of the present invention is to perfect an efficient method for producing flat shaped elements.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, an apparatus according to the present invention for producing flat shaped elements comprises at least one laser source for feeding a laser beam to a fixed focal length laser head for processing the flat elements.

According to one aspect of the invention, the apparatus comprises a Delta robot provided with a plurality of mechanical arms which are associated with the laser head in order to move the latter, and an optical system for deflecting the laser beam provided with at least a first deflection device which receives the laser beam from the laser source and sends it to at least a second deflection device integral with the laser head.

The laser beam is therefore directed from the first deflection device to the second deflection device with continuity, as a function of the motion and position of the laser head, thus following the displacements of the latter.

The use of a Delta robot, unlike the robotic systems used for example in FR26635831 and EP2740563A1, allows the present apparatus to be extremely precise and fast in the operations of moving the laser head and therefore processing the flat elements. The linear cutting speeds that can be achieved are many times higher than those of a plotter, and comparable to those of a galvanometric head.

Thanks to the combined use of the Delta robot for moving the laser head in space and the optical system, the present apparatus is extremely efficient and allows for a significant increase in productivity compared to the apparatuses known in the sector.

The present apparatus also allows to carry out processing with high levels of performance, speed, great precision and substantially continuously, even on large work areas.

Furthermore, in the present apparatus, advantageously, galvanometric heads are not used, therefore its manufacturing costs are low.

Moreover, the present apparatus has a lower environmental impact compared to known apparatuses because, thanks to its efficiency and speed, the power required for any processing, and therefore the consumption of electrical energy, is drastically reduced.

According to another aspect of the invention, each of the mechanical arms is connected, by means of an articulation, to a support on which the laser head is positioned.

According to another aspect of the invention, the support is substantially parallel to a plane where the flat elements lie.

According to another aspect of the invention, each of the mechanical arms comprises a corresponding movement motor.

According to another aspect of the invention, each of the mechanical arms comprises a first section connected to the motor and a second section connected, by means of another articulation, to the first section and, by means of said articulation, to the support.

According to another aspect of the invention, the first deflection device comprises a mirror associated with a motor which allows it to rotate around at least one given axis.

According to another aspect of the invention, the first deflection device comprises a support by means of which it can be placed in a fixed position with respect to the second deflection device and the laser head.

According to another aspect of the invention, the optical system comprises another deflection device for deflecting the laser beam positioned between the laser source and the first deflection device.

According to another aspect of the invention, the first deflection device is mobile in one sense or the other at least in a direction of translation of the laser head.

According to another aspect of the invention, the deflection device is configured to move simultaneously with the laser head, so as to supply a segment of laser beam in a direction substantially orthogonal to the direction of translation of the laser head.

According to another aspect of the invention, the deflection device is positioned on a sliding block sliding in one sense or the other on a guide located to the side of the laser head.

According to another aspect of the invention, the optical system comprises a pair of other deflection devices configured to reverse the direction of the laser beam at exit from the laser source and send it to the mobile deflection device.

According to another aspect of the invention, the second deflection device comprises a mirror associated with a motor which allows it to rotate around at least one given axis.

According to another aspect of the invention, the apparatus comprises a lens for focusing the laser beam on the flat element being processed.

According to another aspect of the invention, the apparatus comprises a control unit configured to manage and govern at least the operation of the Delta robot, the optical system and the laser head.

According to another aspect of the invention, the apparatus' mobile parts, such as the Delta robot, the laser head, or others, are produced using Generative Design and Additive Manufacturing techniques.

The invention also concerns a method for producing flat shaped elements, comprising the feed, by means of at least one laser source, of a laser beam to a fixed focal length laser head for processing the flat elements, the movement of the laser head in space by means of a Delta robot provided with a plurality of mechanical arms which are associated with the laser head, a first deflection of the laser beam by means of an optical system provided with at least a first deflection device which receives the laser beam from the laser source and sends it to at least a second deflection device integral with the laser head.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a three-dimensional view of an apparatus for producing flat shaped elements according to the present invention;

FIG. 2 is a larger scale three-dimensional view of a zone of the apparatus where a laser head is provided;

FIG. 3 is a three-dimensional view of the present apparatus provided with a mobile device for deflecting a laser beam toward the laser head;

FIG. 4 is a larger scale three-dimensional view of a zone of the apparatus of FIG. 3 where said laser head is provided.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

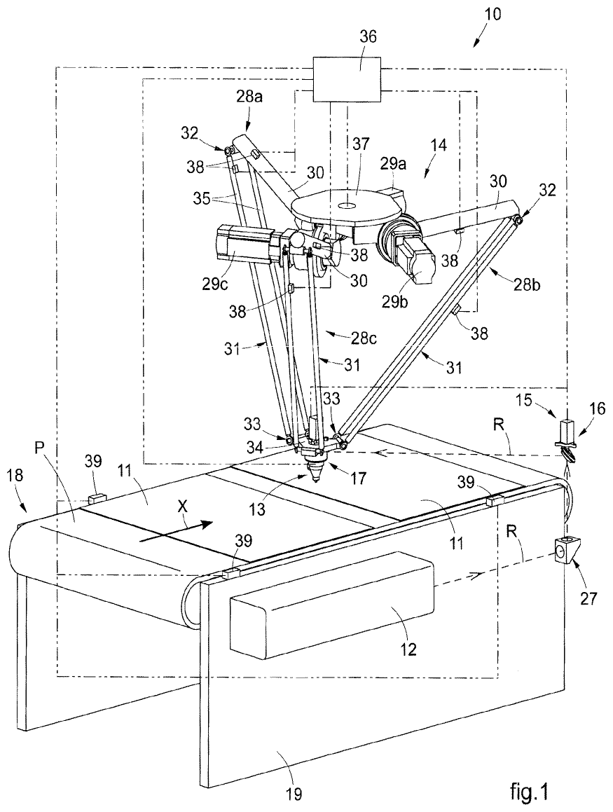

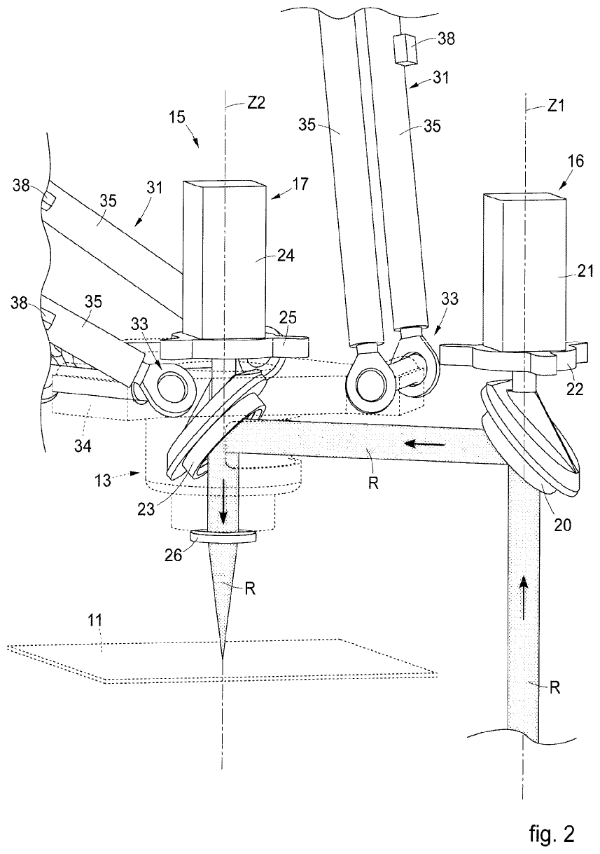

With reference to FIGS. 1 and 2 of the attached drawings, an apparatus 10 for producing flat shaped elements 11 comprises at least one laser source 12 for feeding a laser beam R to a fixed focal length laser head 13 for processing the flat elements 11.

The apparatus 10 is provided with a Delta robot 14 provided with a plurality of mechanical arms 28a, 28b, 28c which are associated with the laser head 13, so as to move it in space. The apparatus 10 is also provided with an optical system 15 for deflecting the laser beam R.

In particular, the space in which the laser head 13 is moved is three-dimensional and defined by Cartesian axes X, Y, Z.

The optical system 15 is provided with at least a first deflection device 16 which receives the laser beam R from the laser source 12 and sends it to at least a second deflection device 17 integral with the laser head 13. The laser beam R is therefore continuously directed from the first deflection device 16 to the second deflection device 17 which the optical system 15 is provided with, as a function of the motion and position of the laser head 13, thus following the displacements of the latter.

The apparatus 10 is provided with a movement system 18, for example a conveyor belt or suchlike, able to move the flat elements 11 in the direction X to the proximity of the laser head 13. The flat elements 11 lie on a plane P of the apparatus 10, in particular of the movement system 18.

In FIG. 1, the movement system 18 is shown with a limited length, but of course it can be made of a much greater length and provide a sequence of flat elements 11 that, on each occasion, arrive in the proximity of the laser head 13.

The movement system 18 is housed on a base 19 of the apparatus 10, on which the laser source 12 can be positioned, for example laterally.

The first deflection device 16 comprises a mirror 20 associated with a motor 21 that allows it to rotate around at least one axis Z1.

The axis Z1 can be substantially vertical.

Substantially, therefore, the first deflection device 16 is configured to be oriented with continuity toward the second deflection device 17.

The first deflection device 16 is in a fixed position, that is, it can be provided with a support 22 connectable to the base 19, for example.

The second deflection device 17 comprises a mirror 24 associated with a motor 24 that allows it to rotate around at least one axis Z2.

The axis Z2 can be substantially vertical and parallel to the axis Z1.

The second deflection device 17 is therefore configured to be continuously oriented in the direction from which the laser beam R arrives, at any point in space in which the laser head 13 is located.

The second deflection device 17 is mobile together with the laser head 13, that is, it can be provided with a support 25 connectable to the laser head 13.

Following the second deflection device 17, the apparatus 10 comprises a lens 26 for focusing the laser beam R on the flat element 11 being processed.

The lens 26 can preferably be housed in the laser head 13.

Another deflection device 27 for deflecting the laser beam R can be provided in the optical system 15, between the laser source 12 and the first deflection device 16, for example if the laser source 12 is positioned at a lower height than the one at which the flat elements 11 to be processed are positioned. The other deflection device 27, such as a mirror or suchlike, deflects the laser beam R by about 90°.

The mechanical arms 28a, 28b, 28c of the Delta robot 14 are driven by corresponding motors 29a, 29b, 29c, which can be supported in particular by a plate 37 positioned at the upper part. In particular, three mechanical arms 28a, 28b, 28c are provided, each equipped with a corresponding motor 29a, 29b, 29c. Each of the mechanical arms 28a, 28b, 28c is connected by means of an articulation 33 to a support 34 on which the laser head 13 is positioned. The support 34 is substantially parallel to the plane P where the flat elements 11 lie. Each of the mechanical arms 28a, 28b, 28c comprises a first section 30 connected to the corresponding motor 29a, 29b, 29c and a second section 31 connected by means of another articulation 32 to the first section 30 and by means of the articulation 33 to the support 34, which during use is positioned in proximity to the flat element 11 to be processed.

The mechanical arms 28a, 28b, 28c are substantially disposed in such a way as to form a parallelogram and the support 34, connected to the end thereof by means of the articulations 33, can only move in parallel planes. In other words, the Delta robot 14 can displace the support 34 in the direction of the three Cartesian axes X, Y and Z without inclining the support 34. This allows for great precision in the positioning of the laser head 13.

The second section 31, as shown by way of example, can consist of two parallel rods 35. The support 34 is connected to the end of the rods 35 by means of the articulation 33, see in particular FIG. 2. The articulation 33 can in this case provide a pair of spherical joints, or suchlike. In the event that the second section 31 provides a single element, the articulation 33 can for example provide a single spherical joint. The first section 30 can be a single element, as shown by way of example.

Thanks to the presence of mechanical arms 28a, 28b, 28c associated with respective motors 29a, 29b, 29c, the support 34 and therefore the laser head 13 can be moved in a three-dimensional space, and in particular on the area affected by the flat element 11 to be processed.

The apparatus 10 comprises a control unit 36 configured to manage and govern at least the operation of the Delta robot 14, the optical system 15 and the laser head 13, so as to coordinate their operation and make the apparatus 10 extremely fast and efficient in processing the flat element 11.

The Delta robot 14, the optical system 15 and the laser head 13 will be provided with sensors, suitably positioned and able to transmit to the control unit 36 information about, for example, the current positioning of the mechanical arms 28a, 28b, 28c, of the deflection devices 16 and 17, of the laser head 13 or others.

According to some embodiments, sensors 38 can be provided positioned on the mechanical arms 28a, 28b, 28c, for example on one or both of either the first section 30 or the second section 31, configured to monitor any deformations of the mechanical arms 28a, 28b, 28c, caused in particular by their movement and possibly also their position.

Sensors 39 can be provided, configured to monitor at least the position of the flat elements 11 in the direction of advance X defined by the movement system 18.

The control unit 36 preferably manages and governs the operation of the system 18 for moving the flat elements 11 to be processed, so as to coordinate their displacement in the direction X with the operation of the Delta robot 14, the optical system 15 and the laser head 13.

Thanks to the coordination between the Delta robot 14 and the laser head 13, the apparatus 10 allows to process the flat elements 11 in a manner that is called, in jargon, “On-The-Fly”, that is, it allows them to be cut while they are moved in the direction of advance X.

The control unit 36 can also be configured to receive the data detected by the sensors 38 so as to monitor any deformations of the mechanical arms 28a, 28b, 28c and command the respective motors 29a, 29b, 29c in order to compensate for the deformations and move the laser head 13 into the desired positions.

The control unit 36 can provide an artificial intelligence and machine learning based hardware and software system. The hardware and software system is configured to synchronize at least the drive of the Delta robot 14, the optical system 15 and the laser head 13. This synchronization is useful to obtain a precise processing of the flat elements 11 by means of the laser head 13.

This hardware and software system can in particular be based on machine learning of a laser cutting process.

The laser head 13, see FIG. 2, focuses the laser beam R on a plane orthogonal to the beam itself, that is, the plane on which the flat element 11 lies. The control unit 36 is also connected to the laser source 12 for feeding the laser beam R, so as to suitably command its operation.

Some of the mobile parts of the present apparatus 10, such as for example the mechanical arms 28a, 28b, 28c, the laser head 13, or others, can be produced using Generative Design, or using a software that automatically creates their structure on the basis of the data entered by the designer.

The model of the mobile part can be materially created using Additive Manufacturing, for example 3D printing. In essence, using Generative Design it is possible to develop an ultralight 3D CAD model of the parts that make up the mobile part, and using Additive Manufacturing it is possible to produce the parts with lightweight materials, for example plastic materials or suchlike.

The Generative Design technique allows to design all the mobile parts so that they have high robustness with a minimum mass, while the Additive Manufacturing technique allows to create the complex shapes resulting from the design, which cannot be produced with the conventional subtractive technique.

This approach allows to operate trajectories with remarkable dynamics, high precision and without vibrations. Without these peculiarities, the apparatus described here would not make sense, since there are simpler conventional systems (laser plotters) that achieve the same operating result even if with extremely low production capabilities. The low production capabilities of traditional solutions are one of the reasons laser cutting cannot be widely used.

The combination of Generative Design and Additive Manufacturing allows to drastically reduce the mass of the moving parts, while keeping unchanged the structural mechanical rigidity of the same moving parts, designed with classic methods.

This combination of features therefore allows to use a Delta robot 14, which is generally used for “pick & place” operations, where high precision in reaching the arrival points is required, while the trajectory followed is normally disorderly, since it is possible control the trajectory of the laser head 13 in an extremely accurate manner, and thus achieve a clean and precise cut of the flat element 11. For example, by means of the present apparatus 10 it is possible to operate with work areas with a diameter of about 2-2.5 m, obtain speeds and accelerations of the laser head 12 of up to about 6 m/s and up to about 11 G (108m/s² ), obtain an absolute precision of the movement device 18 of the flat shaped elements 11 of 0.1 mm, and also guarantee high productivity.

As mentioned, the deformations of the moving parts caused by the acceleration, in particular of the mechanical arms 28a, 28b, 28c, can be evaluated by the control unit 36 using the sensors 38 which report their behavior and can also allow the control unit 36 to predict and correct the deformations, using the technique of machine learning, for example by decreasing the movement speed or by adapting the trajectory of the laser head 13 in such a way as to obtain the desired shaped profile even with high speeds and deformations of the mechanical arms 28a, 28b, 28c, acting on the respected motor members 29a, 29b, 29c.

A method for producing the flat shaped elements 11 comprises the feed, by means of the laser source 12, of the laser beam R to the fixed focal length laser head 13 for processing the flat elements 11, the movement of the laser head 13 in space by means of the Delta robot 14, a first deflection of the laser beam R by means of the optical system 15 provided with the first deflection device 16 which receives the laser beam R from the laser source 12 and sends it to the second deflection device 17 integral with the laser head 13.

According to some embodiments, the method provides to position the laser head 13 at a distance from the flat element 11 comprised between about 60-65 mm (2.5″) and about 190 mm (7.5″) so as to be able to use a laser source with reduced power, for example comprised between about 150 W and about 600 W.

According to other embodiments, the method provides to focus the laser beam downstream of the first 16 and of the second 17 deflection device.

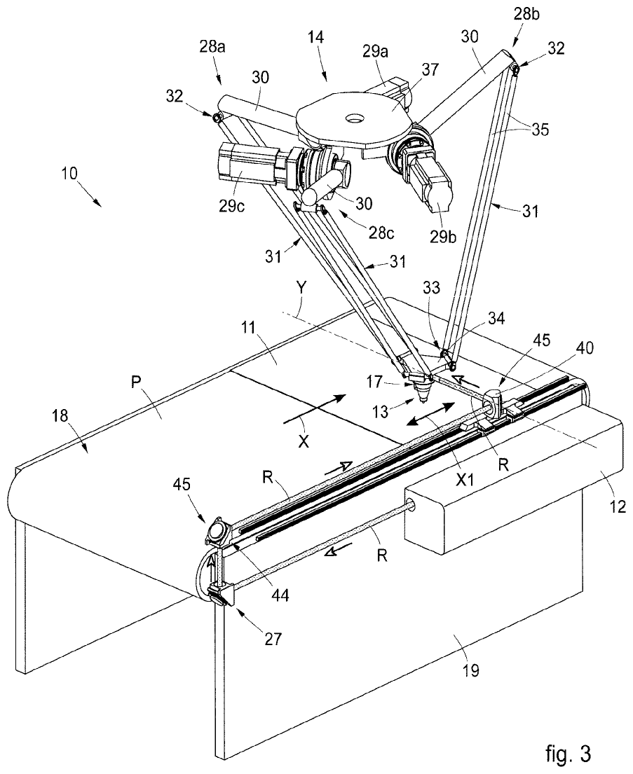

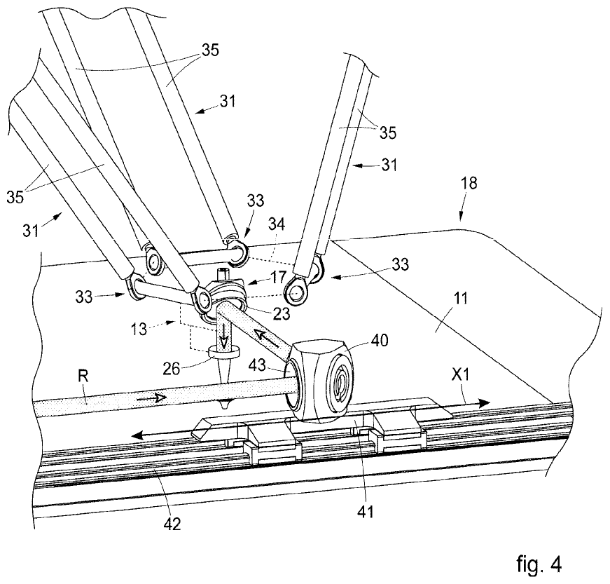

FIG. 3 and FIG. 4 show the present apparatus 10 provided with a mobile deflection device 40. The deflection device 40 moves at least in one sense or the other in a direction X1 of translation of the laser head 13. This direction X1 is substantially one of advance or retraction of the laser head 13, whereby it substantially coincides with the direction X of movement of the flat elements 11. The deflection device 40 moves simultaneously with the laser head 13, substantially following it, so as to supply a segment of laser beam R in a direction Y substantially orthogonal to the direction X1.

When the laser head 13 has a movement in direction Y to the direction X1, the deflection device 40 remains stationary.

This solution allows to keep the mirror 23, mounted on the deflection device 17 integral with the cutting head 13, fixed, that is, not rotating, with consequent construction simplifications.

The deflection device 40 is positioned on a sliding block 41 sliding in one sense or the other on a guide 42 located on the side of the laser head 13, in particular on the side of the base 19 and of the movement device 18. The sliding block 41 is sliding along the guide 42 by means of corresponding drive means. The guide 42 is positioned in the direction X1. The means for moving the sliding block 41 along the guide 42 can be governed by the control unit 36, in particular in order to guarantee that the movement of the sliding block 41 and that of the laser head 13 are simultaneous, when the sliding block 41 moves in the direction X1.

The deflection device 40 is provided with a mirror 43 configured to deflect the laser beam R from the direction X1 to the direction Y.

The laser source 12 in particular sends the laser beam R to the deflection device 27, which is aligned substantially vertically with another deflection device 44 that reverses the direction of the laser beam R with respect to the exit from the laser source 12 and sends it to the mobile deflection device 40.

The optical system 45 for deflecting the laser beam R, as a function of how the laser source 12 is positioned, comprises at least the deflection device 40 and possibly the other deflection devices 27 and 44.

The apparatus 10 of FIG. 3, similarly to what is provided in FIG. 1, will comprise the sensors 38, 39 and the control unit 36, which have been omitted for a clearer illustration.

It is clear that modifications and/or additions of parts may be made to the apparatus and method as described heretofore, without departing from the field and scope of the present invention, as defined by the claims.

It is also clear that, although the present invention has been described with reference to some specific examples, a person of skill in the art will be able to achieve other equivalent forms of apparatus and method for producing flat shaped elements, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. An apparatus for producing flat shaped elements comprising at least one laser source for feeding a laser beam (R) to a fixed focal length processing laser head, wherein the laser head comprises a Delta robot provided with a plurality of mechanical arms which are associated with said laser head in order to move the latter, and an optical system for deflecting said laser beam (R) provided with at least a first deflection device which receives said laser beam (R) from said laser source and sends it to at least a second deflection device integral with said laser head.

2. The apparatus according to claim 1, wherein each of said mechanical arms is connected, by means of an articulation to a support on which said laser head is positioned.

3. The apparatus according to claim 2, wherein said support is substantially parallel to a plane (P) where said flat elements lie.

4. The apparatus according to claim 1, wherein each of said mechanical arms comprises a corresponding movement motor.

5. The apparatus according to claim 4, wherein each of said mechanical arms comprises a first section connected to said motor and a second section connected, by means of another articulation, to said first section and, by means of said articulation to said support.

6. The apparatus according to claim 1, wherein said first deflection device (16) comprises a mirror (20) associated with a motor (21) which allows it to rotate around at least one given axis (Z1).

7. The apparatus according to claim 1, wherein said first deflection device (16) is in a fixed position with respect to said second deflection device (17) and said laser head (13).

8. The apparatus according to claim 1, wherein said optical system (15) comprises another deflection device (27) for deflecting said laser beam (R) positioned between said laser source and said first deflection device (16).

9. The apparatus according to claim 1, wherein said first deflection device is mobile in one sense or the other at least in a direction (X1) of translation of said laser head.

10. The apparatus according to claim 9, wherein said deflection device (40) is configured to move simultaneously with said laser head (13), so as to supply a segment of laser beam (R) in a direction (Y) substantially orthogonal to said direction (X1) of translation of said laser head (13).

11. The apparatus according to claim 9, wherein said deflection device is positioned on a sliding block sliding in one sense or the other on a guide located to the side of said laser head.

12. The apparatus according to claim 9, wherein said optical system comprises a pair of other deflection devices configured to reverse the direction of said laser beam (R) at exit from said laser source and send it to said mobile deflection device.

13. The apparatus according to claim 1, wherein said second deflection device comprises a mirror associated with a motor which allows it to rotate around at least one given axis.

14. The apparatus according to claim 1, wherein it comprises a lens for focusing said laser beam on the flat element.

15. The apparatus according to claim 1, wherein it comprises sensors configured to monitor the position and any deformations of said Delta robot, and sensors configured to monitor at least the position of said flat elements in a direction of advance (X), and a control unit configured to manage and govern at least the operation of said Delta robot said optical system and said laser head also as a function of the data received from said sensors.

16. The apparatus according to claim 1, wherein its mobile parts, such as said Delta robot, said laser head, or others, are produced using Generative Design and Additive Manufacturing techniques.

17. A method for producing flat shaped elements comprising the feed, by means of at least one laser source of a laser beam (R) to a fixed focal length laser head for processing said flat elements the movement of said laser head in space by means of a Delta robot provided with a plurality of mechanical arms which are associated with said laser head, a first deflection of said laser beam (R) by means of an optical system provided with at least a first deflection device which receives said laser beam (R) from said laser source and sends it to at least a second deflection device integral with said laser head.
